(19) United States
(12) Patent Application Publication
(10) Pub. No.: US 2012/0183467 A1
(43) Pub. Date: Jul. 19, 2012

(54) LOW TEMPERATURE OXIDATION OF AMMONIA IN NITRIC ACID PRODUCTION

(75) Inventors: Gongshin Qi, Troy, MI (US); Wei Li, Troy, MI (US); Steven J. Schmieg, Troy, MI (US); Chang H. Kim, Rochester, MI (US); David B. Brown, Brighton, MI (US)

(73) Assignee: GM GLOBAL TECHNOLOGY OPERATIONS LLC, DETROIT, MI (US)

(21) Appl. No.: 13/006,460

(22) Filed: Jan. 14, 2011

(51) Int. Cl. C01B 21/38

(52) U.S. Cl. 423/392

(57) ABSTRACT

Ammonia in a gas stream comprising oxygen and nitrogen may be effectively completely oxidized to a mixture of NO and NO₂ for further processing to nitric acid. The gas stream is flowed over fine particles of La₁₋ₓSrₓCoO₃ and/or La₁₋ₓSrₓMnO₃, and/or La₁₋ₓSrₓFeO₃ where x=about 0.1, 0.2, or 0.3. The particles are supported as catalyst layers on gas stream-contacting surfaces of a flow-through catalyzed oxidation reactor. These relatively inexpensive perovskite-type materials may be used to promote oxidation of ammonia at temperatures below about 450° C. to about 500° C. to selectively produce a mixture of NO and NO₂. This mixture is suitable for further oxidation to NO₂ for adsorption into water to make nitric acid.

### TECHNICAL FIELD

This invention pertains to the use of selected perovskite compositions as catalysts for the low temperature oxidation of ammonia to nitrogen oxides in the manufacture of nitric acid. More specifically, this invention pertains to the use of certain lanthanum-containing and strontium-containing perovskites as catalysts to oxidize ammonia selectively and in high yields to mixtures of nitrogen oxide (NO) and nitrogen dioxide (NO₂) useful in making nitric acid.

### BACKGROUND OF THE INVENTION

Nitric acid is a strong, monobasic mineral acid, and aqueous solutions of this oxidizing acid are used in many industrial processes, and in the making of many useful articles of manufacture.

Nitric acid is made on an industrial scale by the oxidation of ammonia to nitrogen monoxide (NO), the further oxidation of nitrogen monoxide to nitrogen dioxide (NO₂), and the absorption of nitrogen dioxide into water. Platinum gauze has been used to catalyze the oxidation of ammonia to NO, but this reaction has required temperatures of 810 to 850° C. at atmospheric pressure, or 920 to 940° C. at 0.8 MPa, for suitable ammonia conversion and obtaining the desired nitrogen oxide. And the expensive noble metal (a pad of fine platinum-alloy gauzes) is gradually lost from the gauze by volatilization of platinum oxide. There is a need for a lower catalyst cost and lower temperature method to oxidize ammonia to suitable nitrogen oxides for obtaining nitric acid.

### SUMMARY OF THE INVENTION

It is found that certain perovskite-type compositions may be prepared and used to oxidize ammonia to a mixture of nitrogen oxide and nitrogen dioxide at temperatures, for example, in the range of about 400° C. to about 450° C. (temperatures well below 500° C.). The compositions are La₁₋ₓSrₓCoO₃, La₁₋ₓSrₓMnO₃, and La₁₋ₓSrₓFeO₃, where the value of x, indicating the atomic proportions of strontium and lanthanum (totaling 1) is suitably on the range of about 0.1 to 0.3. A perovskite-type catalyst of one or more of these compositions is prepared as fine particles for support on surfaces in a flow-through reactor maintained at the oxidation temperature. A gas stream containing suitable portions of ammonia, oxygen, and nitrogen is flowed over the catalyst at a suitable volumetric flow rate for the volume or surface area of the catalyst. For example, the gas stream may be composed of mixtures of ammonia, oxygen, and nitrogen. In some embodiments air may be used to provide oxygen. Such mixtures of ammonia and oxygen may comprise up to about ten percent by volume of ammonia with at least a stoichiometric amount of oxygen for the oxidation reactions. The ammonia is oxidized, substantially selectively, to a mixture of nitrogen monoxide (NO, a.k.a., nitric oxide) and nitrogen dioxide (NO₂). Water is formed as a by-product.

The NO and NO₂ containing gas stream, flowing from the catalyst-carrying surfaces of the oxidation reactor, may be cooled and processed to nitric acid by known practices. For example, the gas stream may be subjected to a second oxidation step in which the NO in the mixed stream is oxidized to NO₂. The NO₂-containing stream is then circulated through an absorption column in which the NO₂ is absorbed into water to form a solution of HNO₃. The aqueous acid solution is recirculated in the absorption column until a suitable concentration of nitric acid in water is obtained for further down-stream processing.

In accordance with embodiments of this invention, the lanthanum-containing and strontium-containing perovskite composition is used in a manner that enables the stated, relatively low temperature oxidation of ammonia in the first step of nitric acid synthesis. In a preferred embodiment, La₁₋ₓSrₓCoO₃ and/or La₁₋ₓSrₓMnO₃ and/or La₁₋ₓSrₓFeO₃ material is prepared and used in the form of a washcoat layer(s) of fine particles of the perovskite composition on the walls of a multichannel, high catalyst surface area, flow-through oxidation reactor. For example, the reactor body may be an extruded, cylindrical, cordierite honeycomb body with many parallel, open-ended channels extending from an inlet face of the body to an outlet face. In a suitable embodiment, the extruded body has 400 channel openings per square inch of inlet and outlet faces surface area. As will be described below in this specification, an aqueous dispersion of fine particles of one or more of the La₁₋ₓSrₓCoO₃ and/or La₁₋ₓSrₓMnO₃ and/or La₁₋ₓSrₓFeO₃ material is applied to and baked onto the walls of the channels in the extruded body.

The prepared catalyst body may be supported and confined in a suitable open-ended, cylindrical metal body which is heated to the oxidation temperature of about 400° C. to 450° C. A stream of ammonia and oxygen, suitably diluted in nitrogen, or the like, is passed through the multichannel catalyst body at a flow rate for substantially complete and selective oxidation of the ammonia to a mixture of NO and NO₂. As described above, this stream of mixed nitrogen oxides is an important (and now relatively low cost) intermediate product stream for the production of nitric acid.

Other objects and advantages of the invention will be apparent from a description and illustration of preferred embodiments which follows in this specification. In this description reference is had to drawing figures which are described in the next section of this specification.

### BRIEF DESCRIPTION OF THE DRAWINGS

FIG. 1 is an oblique view of an illustrative relatively low temperature, cylindrical, flow-through, and oxidation reactor for the oxidation of ammonia with oxygen to a mixture of nitrogen oxides suitable for further processing to nitric acid. In the figure, the reactor housing is partly broken away to show the extruded, multi-channel catalyst carrier in which the oxidation of ammonia is promoted.

FIG. 2 is a graph of percent conversion of ammonia (solid line) to nitrogen oxides versus temperature (degrees Celsius) using La_{0.9}Sr_{0.1}CoO₃ as the catalyst. The graph of FIG. 2 also presents the percent selectivity of nitrogen oxide formation (dashed line) with temperature in degrees Celsius. Selectivity refers to the molar ratios of the formation of a mixture of NO to NO₂ in the oxidized ammonia stream to the total NH₃ converted at certain temperatures.

### DESCRIPTION OF PREFERRED EMBODIMENTS

It is found that certain strontium-substituted, lanthanum cobalt oxide perovskites and strontium-substituted, lanthanum manganese oxide perovskites may be adapted as catalyzed washcoat materials for the oxidation of ammonia with oxygen at relatively low oxidation temperatures. The empirical formulas of these compositions are La₁₋ₓSrₓCoO₃ and La₁₋ₓSrₓMnO₃ where x=0.1, 0.2, 0.3.

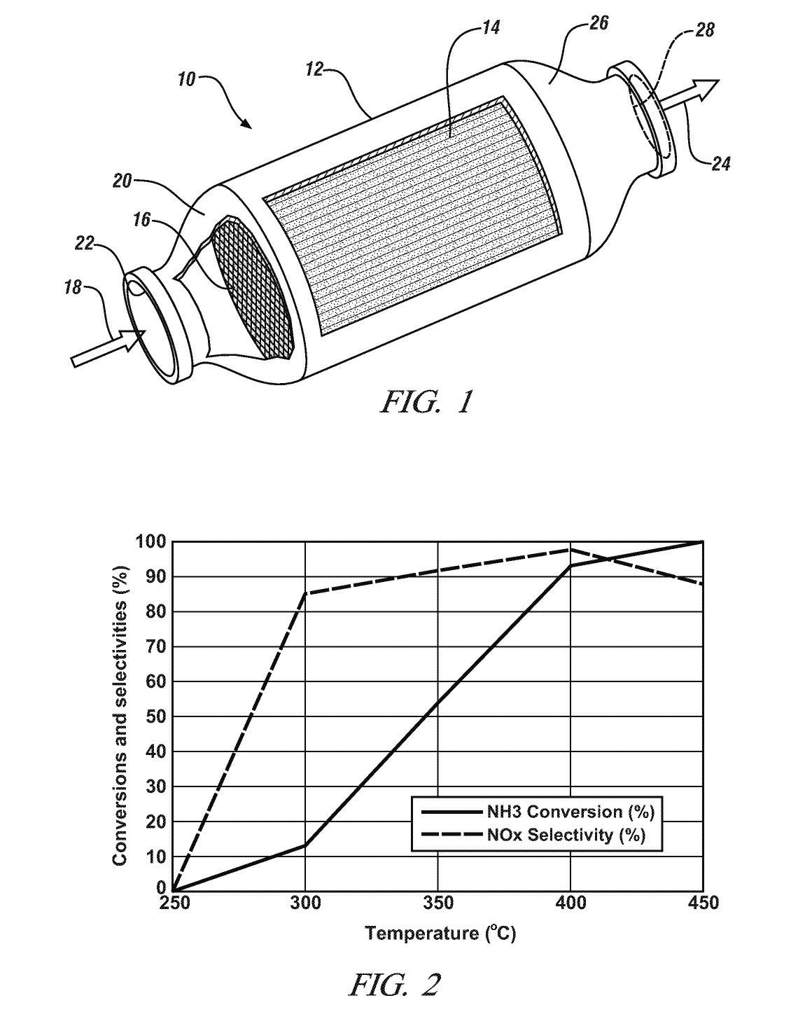

These strontium-containing, perovskite compositions were prepared and applied as fine particle wash coatings on extruded cordierite honeycomb flow-through bodies for the oxidation of a gas stream comprising ammonia to mixed nitrogen oxides (substantially exclusively NO and NO₂) as a suitable and useful precursor stream for the synthesis of nitric acid. A suitable catalyzed oxidation reactor body is illustrated in FIG. 1.

Referring to FIG. 1, perovskite-catalyzed, ammonia oxidation reactor 10 may comprise a round tubular stainless steel body 12 for tightly enclosing, for example, an extruded, round cylindrical, honeycomb shaped, cordierite catalyst support body 14 which is seen in the broken-out window in the side of body 12. Support body 14 is suitably of uniform cross-section along its length. It may be formed of other known and suitable ceramic or metallic materials. In this embodiment, cordierite support body 14 is formed with many exhaust gas flow-through channels that extend from an upstream, exhaust gas inlet face 16 of the catalsyt support body to a downstream, exhaust gas outlet face of like shape and area (not visible in FIG. 1) of the catalyst support body. These small flow-through channels are represented as crossing lines in the illustration of exhaust gas inlet face 16. For example, 400 square flow-through channels per square inch of inlet face are typically formed during extrusion of the ceramic body. A strontium-substituted, perovskite, fine particle catalyst in the form of a washcoat is coated on the walls of each of the channels of the honeycomb structure. The diameter of steel body 12 and enclosed pervskite oxidation catalyst support body 14 is enlarged with respect to the upstream and downstream exhaust flow conduits so as to reduce drag on the exhaust stream as it engages the inlet face 16 of the catalyst support body 14 and flows through the many washcoated channels. The outer surface of support body 14 is suitably sealed against the inside of steel body 12 so that flow of an ammonia and oxygen stream is directed through the many channels and into contact with the supported perovskite catalyst on the channel walls of support body 14.

As seen in FIG. 1, the upstream end of steel enclosure body 12 (as indicated by exhaust flow direction arrow 18) is enclosed by an expanding stainless steel, ammonia stream inlet section 20. Ammonia stream inlet 22 of inlet section 20 is sized and adapted to receive an ammonia stream flow prepared and, optionally, preheated upstream of inlet 22. The downstream end (oxidized stream flow direction arrow 24) of steel enclosure body 12 is enclosed by a flow narrowing, steel exhaust section 26 with an exhaust outlet 28 adapted to be connected to a conduit for conducting an oxidized ammonia stream to a cooling stage preparatory for futher oxidiation of the mixed nitrogen oxides in the oxidized stream.

A temperature sensor (not illustrated in FIG. 1) may be located within steel enclosure body 12. Such a sensor may be located, for example, at the upstream and/or the downstream end of catalyst support body 14.

A suitable strontium-containing perovskite washcoat material may be prepared for application onto a catalyst support body as follows. The description will illustrate the preparation of laboratory quantities used in demonstrating the effective low-temperature oxidation of ammonia to mixed nitrogen oxides in accordance with preferred embodiments of the invention.

La₁₋ₓSrₓCoO₃ (x=0.1, 0.2, 0.3) and La₁₋ₓSrₓMnO₃ (x=0.1) catalysts were prepared using citric acid. Citric acid is a crystalline hydroxyl tricarboxylic acid and is useful in aqueous solutions to interact with multiple different metal cations, also added to the solution, to combine the metals in an ionized complex in the solution. A suitable method for forming these perovskite compositions in a form to effectively catalyze the lower temperature oxidation of ammonia to nitrogen oxides, in route to nitric acid, is as follows.

In the method, appropriate amounts (referring to the above empirical formulas) of La(NO₃)₃.6H₂O, Co(NO₃)₂.6H₂O, Mn(NO₃)₂ solution, and Sr(NO₃)₂ were dissolved in distilled water with citric acid monohydrate. Citric acid was added in a 10 wt % excess to ensure complete complexation of the metal ions. The amount of water used was 46.2 mL/g of La(NO₃)₃.6H₂O. The solution was stirred for 1 hour, and then heated to 80° C. with continued stirring. Water was evaporated until the solution became a viscous gel and just began evolving NO₂ gas. The gel was then placed overnight in an oven, set at 90° C. After such further dehydration, the resulting spongy material was crushed and calcined at 700° C. for 5 hours in static air. The temperature was ramped from ambient temperature to the final calcination temperature at a rate of 10° C./min. When the temperature reached just below 300° C., the citrate ions combusted vigorously, causing a large spike in temperature and powder displacement. For this reason the powder was covered with several layers of ZrO₂ balls (the same as used for subsequent ball milling) to prevent powder displacement, but still allow gas mobility.

After calcination, the powder was ball milled with 6.33 mL water/g powder for 24 hours. Each thus-prepared, strontium-containing perovskite material was considered suitable for further preparation as a fine particle washcoat material for deposit on the walls of a multichannel, flow-through oxidation reactor body for the oxidation of ammonia to mixed nitrogen oxides. A suitable catalyst carrying body is the extruded cordierite honeycomb structure illustrated in FIG. 1.

The ball-milled slurry was stirred continuously and 0.33 mL aqueous 0.1 M HNO₃/g powder and 5 mL water/g powder was added. The resulting washcoat dispersion/solution had a concentration of 0.114 g catalyst/mL of the dispersed perovskite particles. The slurry was washcoated onto round cylindrical monolith core samples which were ¾ inch diameter by one inch long, 400 channels per square inch of inlet face area, 4 mil wall thicknesses, extruded and fired cordierite honeycomb bodies. To washcoat, a honeycomb body was dipped in the washcoat solution or 30 to 60 seconds. An air stream was then used to blow excess solution from the substrate's channels, and the wet substrate dried in an oven set at 120 ° C. for 30 to 60 minutes. This procedure was repeated until the desired loading was obtained on the channel walls of the cordierite substrate body. Finally, the catalyst washcoated body was calcined at 700° C. for 5 hours with an air flow rate of 100 sccm. The targeted total washcoat loading was 100 grams per liter of the outer (superficial volume) of the monolith body. After washcoating, each monolithic catalyst was dried and calcined at 550° C. for 5 hrs in static air.

The flow-through, honeycomb catalyst-coated bodies were tested in a horizontal quartz tubular reactor (internal diameter, ¾ in) operated at atmospheric pressure. The gases were fed from individual tanks using a series of mass flow controllers. The gas feed mixture flow rate was 3.00 L/min, corresponding to a space velocity of 25,000 hr⁻¹ (based on the superficial outer volume of the washcoated honeycomb bodies). The feed composition was 10% O₂, 200 ppm NH₃, 5% H₂O, 5% CO₂, all in a balance of N₂. The feed composition was formulated to contain water and carbon dioxide to assure that air could be used as a source of oxygen for the oxidation of ammonia using the subject perovskite-type catalysts.

Each catalyst body was heated in a tube furnace which controlled the temperature just upstream of the catalyst coated monolith body. Thermocouples were used to measure the temperature upstream and downstream of the catalyst. The reactor outlet stream was analyzed with a Fourier Transform Infrared (FTIR) analyzer, calibrated at 940 torr and 165° C. A pressure controller at the outlet of the FTIR was used to maintain the calibration pressure, and the line downstream of the reactor was heated to 165° C. The lines upstream of the reactor were also heated to 165° C. to assure complete vaporization of the water.

FIG. 2 is a graph illustrating the results of an above described oxidation of ammonia using a washcoat of La_{0.9}Sr_{0.1}CoO₃ on a three-quarter inch diameter cordierite honeycomb body prepared as described above in this specification. The tests were conducted with the washcoated body heated to a generally fixed temperature for conduct of the exothermic reaction of ammonia with oxygen.

An inlet gas stream, prepared as described above, to contain, by volume, 5% carbon dioxide, 5% water, 10% oxygen, 200 ppm ammonia, and the balance nitrogen was delivered to the heated flow-through reactor at a space velocity of 30,000 h⁻¹.

In a first step, the oxidation of ammonia may be represented by the following equation:

4NH₃+5O₂→4NO+6H₂O

And as actually conducted in the experiments with the strontium-containing perovskites, the oxidation of ammonia yielded desirable mixtures of NO and NO₂. Little, if any, of other unwanted nitrogen oxides were obtained using the subject catalysts.

Oxidation tests were conducted with the catalyst at 250° C., 300° C., 400° C., and 450° C., respectively, using the ammonia-containing feed stream at the specified space velocity. The purpose of these reactivity tests was to assess the effectiveness of the subject strontium-containing perovskites as catalysts that promote the oxidation of ammonia with oxygen to form nitric oxide or a mixture of nitric oxide and nitrogen dioxide. An important interest in these tests was to determine whether useful oxidation products could be obtained at temperatures below about 500° C.

As presented in FIG. 2, the conversion of the ammonia in the feed stream (solid line) to a mixture of NO and NO₂ reached about 94% at 400° C. and was nearly one-hundred percent conversion at 450° C. This was considered to be a surprising success in that such high conversion levels of ammonia to a useful mixture of nitrogen oxides were attained at temperatures below 500° C. The selectivity of conversion of ammonia to a mixture of NO and NO₂ is seen in the dashed line data line of FIG. 2. As the catalyst temperature was increased from 350° C. to about 450° C., the nitrogen oxide and nitrogen dioxide proportion of the total nitrogen oxides in the exhaust was greater than ninety percent.

In summary, it is found and demonstrated that La₁₋ₓSrₓCoO₃ and/or La₁₋ₓSrₓMnO₃, and/or La₁₋ₓSrₓFeO₃, where x=about 0.1, 0.2, 0.3, are perovskite-type materials that can be prepared in the form of a finely divided particles for placement as a washcoat material on surfaces of a high temperature resistant support body for promoting the oxidation of ammonia to a mixture of nitrogen oxides as precursors for making nitric acid. These useful materials are much less expensive than platinum group metals presently required for ammonia oxidation in the manufacture of nitric acid. And these strontium-containing perovskite materials can work at lower, more energy-efficient temperatures than the catalysts used presently.

Practices of the invention have been illustrated by a few examples that are not limiting of the scope of the invention. The strontium content of the perovskites may be varied as indicated, and the lanthanum strontium cobalt oxides, the lanthanum strontium manganese oxides, and the lanthanum strontium iron oxides may be used alone, in mixtures, or in combinations as wash coat materials on channel surfaces in flow through ammonia oxidation reactors. Preferably, the multi-metal washcoat materials are prepared using a citric acid gel process to combine the metals in the catalyst materials.

1. A process for the oxidation of ammonia to form a mixture of nitrogen monoxide and nitrogen dioxide for the manufacture of nitric acid; the process comprising:
flowing a stream of ammonia-containing and oxygen-containing gas over a supported layer of particles of at least one of La₁₋ₓSrₓCoO₃, La₁₋ₓSrₓMnO₃, and La₁₋ₓSrₓFeO₃, where x=0.1, 0.2, 0.3, the layer of particles being maintained at a temperature below 500° C. to promote substantially complete conversion of the ammonia in the gas stream to nitrogen oxide (NO) and nitrogen dioxide (NO₂), and, thereafter
cooling the nitrogen oxides-containing gas stream that has passed from contact with the supported layer of particles for the further oxidation of NO in the nitrogen oxides-containing gas stream to NO₂, preparatory to the absorption of the total NO₂, as produced in the two oxidation steps, from the gas mixture into water to form nitric acid.

2. A process for the oxidation of ammonia as recited in claim 1 in which the ammonia-containing and oxygen-containing gas stream comprises, by volume, up to ten percent ammonia, at least a stoichiometric amount of oxygen for the formation of a mixture of NO and NO₂, and nitrogen.

3. A process for the oxidation of ammonia as recited in claim 1 in which the supported layer of particles has been deposited as a washcoat layer on channel walls of an extruded, multi-channel, flow-through support body, the support body and washcoat layer being sized to promote the oxidation of the gas stream flowing through the support body at a predetermined flow rate.

4. A process for the oxidation of ammonia as recited in claim 1 in which the supported layer of particles has been formed from a citric acid gel of the metal ions and deposited as a washcoat layer on channel walls of an extruded, multi-channel, flow-through support body, the support body and washcoat layer being sized to promote the oxidation of the gas stream flowing through the support body at a predetermined flow rate.

5. A process for the oxidation of ammonia as recited in claim 1 in which the supported layer of particles has been deposited as a washcoat layer on channel walls of an extruded cordierite, multi-channel, flow-through support body, the support body having a uniform cylindrical cross-section, with inlet and outlet faces having about 400 channels per square inch of face area, the support body and washcoat layer being sized to promote the oxidation of the gas stream flowing through the support body at a predetermined flow rate.

6. A process for the oxidation of ammonia as recited in claim 1 in which the supported layer of particles has been formed from a citric acid gel of the metal ions and deposited as a washcoat layer on channel walls of an extruded cordierite, multi-channel, flow-through support body, the support body having a uniform cylindrical cross-section, with inlet and outlet faces having about 400 channels per square inch of face area, the support body and washcoat layer being sized to promote the oxidation of the gas stream flowing through the support body at a predetermined flow rate.

7. A process for the oxidation of ammonia to form a mixture of nitrogen monoxide and nitrogen dioxide for the manufacture of nitric acid; the process comprising:
flowing a gas stream comprising ammonia, oxygen and nitrogen over a supported layer of particles of at least one of La₁₋ₓSrₓCoO₃, La₁₋ₓSrₓMnO₃, and La₁₋ₓSrₓFeO₃, where x=0.1, 0.2, 0.3, the layer of particles being maintained at a temperature below 500° C. to promote substantially complete conversion of the ammonia in the gas stream to nitrogen oxide (NO) and nitrogen dioxide (NO₂); and, thereafter
oxidizing the nitrogen oxide in the gas stream to nitrogen dioxide.

8. A process for the oxidation of ammonia as recited in claim 7 in which the gas stream comprises, by volume, up to ten percent ammonia, at least a stoichiometric amount of oxygen for the formation of a mixture of NO and NO₂, and nitrogen.

9. A process for the oxidation of ammonia as recited in claim 7 in which the supported layer of particles has been deposited as a washcoat layer on channel walls of an extruded, multi-channel, flow-through support body, the support body and washcoat layer being sized to promote the oxidation of the gas stream flowing through the support body at a predetermined flow rate.

10. A process for the oxidation of ammonia as recited in claim 7 in which the supported layer of particles has been formed from a citric acid gel of the metal ions and deposited as a washcoat layer on channel walls of an extruded cordierite, multi-channel, flow-through support body, the support body having a uniform cylindrical cross-section, with inlet and outlet faces having about 400 channels per square inch of face area, the support body and washcoat layer being sized to promote the oxidation of the gas stream flowing through the support body at a predetermined flow rate.
